(19) United States
(12) Patent Application Publication
(10) Pub. No.: US 2025/0245737 A1
(43) Pub. Date: Jul. 31, 2025

(54) SYSTEM AND METHOD FOR GENERATING A USER INTERFACE PORTION FOR DISPLAYING PAYMENT ACTIVITIES

(71) Applicant: Walmart Apollo, LLC, Bentonville, AR (US)

(72) Inventors: Emily Dong, New York, NY (US); Arka Sinha, San Bruno, CA (US); Olivia Rose Koivisto, Chicago, IL (US); Grecia Andreina Quintero Medina, Cali (CO)

(73) Assignee: Walmart Apollo, LLC, Bentonville, AR (US)

(21) Appl. No.: 18/429,385

(22) Filed: Jan. 31, 2024

(51) Int. Cl. G06Q 40/02; G06Q 20/22

(52) U.S. Cl. CPC G06Q 40/02; G06Q 20/227

(57) ABSTRACT

A method can include generating a user interface portion for a user device. The user interface portion can be for one or more used payment methods for an order payment by a user. To generate the user interface portion, the method can include: (a) upon determining that a payment method count is greater than one, (i) determining a current payment method based on the one or more used payment methods and a payment-method-sequence rule; and (ii) generating a payment-method-selection area of the user interface portion; and (b) upon determining that the payment method count is not greater than one, using the one or more used payment methods as the current payment method. The method further can include generating a ledger area of the user interface portion for the current payment method to display information associated with the current payment method and the order payment. Additionally, the method can include transmitting, via a computer network, a charge-history user interface comprising the user interface portion to be displayed on the user device for the user. Other embodiments are disclosed.

### TECHNICAL FIELD

This disclosure relates generally to techniques for dynamically generating user interfaces.

### BACKGROUND

Conventional payment processing software system, such as online retail platforms or utility bill payment systems, allow users to check the status and a total amount of a payment submitted. However, under certain circumstances, the status and total amount alone might not provide sufficient information for the user. For example, when an online order is in a processing stage, and the user or the seller makes changes to the order (e.g., adding or canceling items), the conventional systems are not designed to break down the payment activities to reflect the changes (e.g., authorization hold or authorization reversal for an order that used a credit card). Without the detailed payment information, the user may be confused as to how the total amount is calculated, and what the multiple payment authorization requests received at the bank and shown on the bank's activity history or statements are for. Further, when multiple payment methods are used for an order payment, merely listing all of the activities for the payment methods can be more confusing. Thus, systems and methods for dynamically generating user interfaces or portions thereof for selectively displaying payment activities, including temporary ones, in real-time are desired.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a system for generating a user interface portion for displaying payment activities, according to an embodiment;

FIG. 4 illustrates a flow chart for a method of generating a user interface portion for a user device for displaying payment activities, according to an embodiment;

FIG. 5 illustrates a flow chart for a method of determining a payment method count for the one or more payment methods used for an order payment to be displayed in a user interface portion, according to an embodiment;

FIG. 6 illustrates a time-series chart for events of an exemplary order payment, according to an embodiment; and

FIG. 7 illustrates an exemplary layout of a user interface with a user interface portion for displaying payment activities, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, ten minutes, or fifteen minutes.

### DESCRIPTION OF EXAMPLES OF EMBODIMENTS

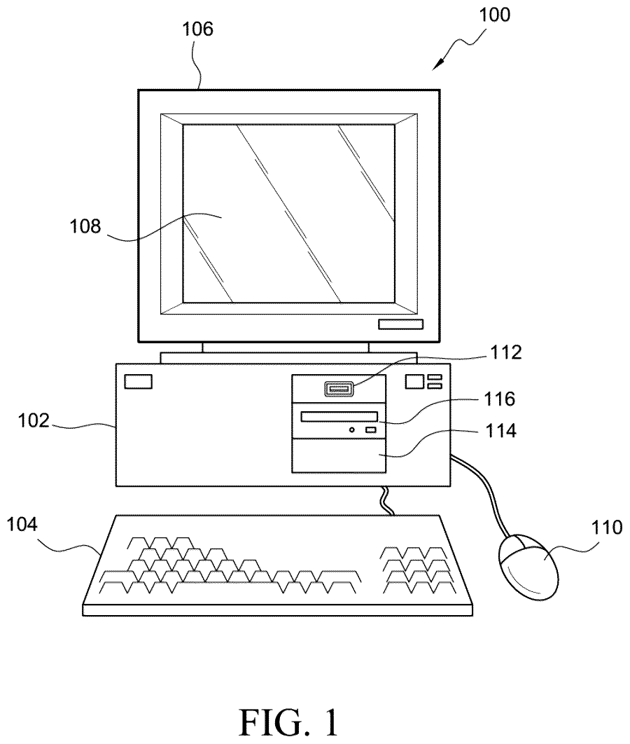

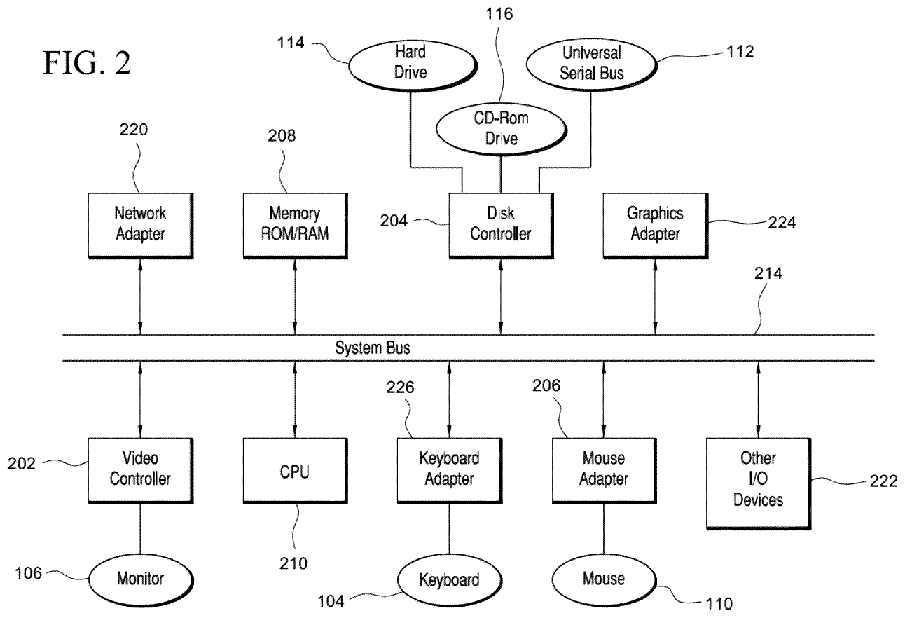

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refers to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such Block as a smartphone. In certain additional embodiments, computer system 100 may comprise an embedded system.

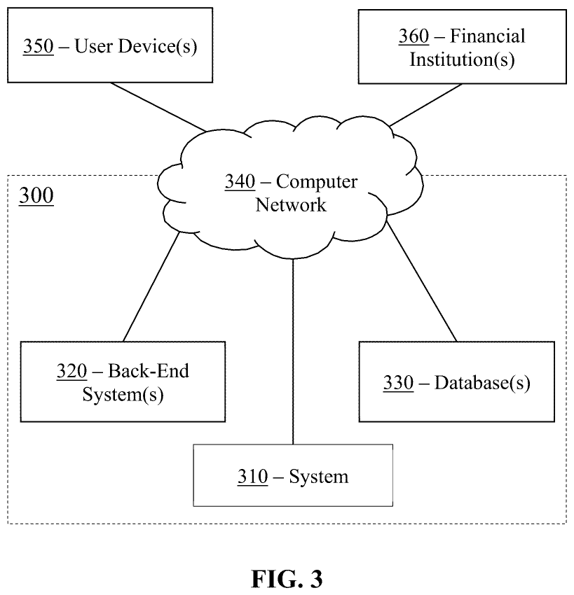

Turning ahead in the drawings, FIG. 3 illustrates a block diagram of a system 300 that can be employed for dynamically generating a user interface portion to display payment activities. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein. In many embodiments, operators and/or administrators of system 300 can manage system 300, the processor(s) of system 300, and/or the memory storage unit(s) of system 300 using the input device(s) and/or display device(s) of system 300, or portions thereof in each case.

In many embodiments, system 300 can include a system 310, a back-end system(s) 320, and/or a database(s) 330 and can be configured to interact with a user device(s) 350 and/or a financial institution(s) 360. System 310 further can include one or more elements, modules, models, or systems to perform various procedures, processes, and/or activities of system 300 and/or system 310. System 310 and back-end system(s) 320 each can be a computer system, such as computer system 100 (FIG. 1), as described above, a single server, a cluster or collection of computers or servers, or a cloud of computers or servers. In another embodiment, a single computer system can host system 310 and back-end system(s) 320. Additional details regarding system 310, back-end system(s) 320, database(s) 330, user device(s) 350, and/or financial institution(s) 360 are described herein.

In some embodiments, system 310 can be in data communication with user device(s) 350, using a computer network (e.g., computer network 340), such as the Internet and/or an internal network that is not open to the public. In several embodiments, user device(s) 350 can be used by users, such as users for an online retailer's websites, customers or potential customers for a retailer, and/or a system operator or administrator for system 310. In certain embodiments, the user devices (e.g., user device(s) 350) can be a mobile device, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, an augmented-reality (AR) headset, a virtual-reality (VR) headset, etc.), or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, system 310 can include one or more input devices (e.g., one or more keyboards, one or more keypads, one or more pointing devices such as a computer mouse or computer mice, one or more touchscreen displays, a microphone, etc.), and/or can comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 310. In a similar manner, the processors and/or the non-transitory computer-readable media can be local and/or remote to each other.

Meanwhile, in many embodiments, system 310 also can be configured to communicate with and/or include database(s) 330. In many embodiments, database(s) 330 can include user account information, including, for example, the respective name, shipping address(es), one or more payment methods, and billing address(es) associated with each user. In certain embodiments, database(s) 330 further can include a product catalog of a retailer that contains information about, for example, products, items, or SKUs (stock keeping units), etc. In some embodiments, database(s) 330 also can include logs of payment activities for orders, including information about payment types used, authorizations or declines of payments that are sent to or received from the user device(s) 350 and/or financial institution(s) 360, for example, among other data as described herein. In another example, database(s) 330 further can include training data (e.g., synthetic and/or historical input and/or output, user feedback, etc.) and/or hyper-parameters for training and/or configuring one or more machine-learning models of, or used by, system 310 and/or back-end system(s) 320.

In a number of embodiments, database(s) 330 can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more data sources, that particular database can be stored on a single memory storage unit or the contents of that particular database can be spread across multiple ones of the memory storage units storing the one or more databases, depending on the size of the particular database and/or the storage capacity of the memory storage units. In similar or different embodiments, the one or more data sources can each be a computer system, such as computer system 100 (FIG. 1), as described above, and can each be a single computer, a single server, or a cluster or collection of computers or servers, or a cloud of computers or servers.

Database(s) 330 can include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

In many embodiments, communication between system 300, system 310, back-end system(s) 320, database(s) 330, user device(s) 350, and/or financial institution(s) 360 can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

Still referring to FIG. 3, in a number of embodiments, system 310 can host one or more websites and/or mobile application servers that interface with an application (e.g., a mobile application, a web browser, or a chat application) on user device(s) 350 for a user. Back-end system(s) 320 can support back-office applications, including managing orders, inventory, and/or supply, processing payments, managing user accounts, monitoring and analyzing user usage of system 300 or 310, scheduling deliveries, and so forth. Back-end system(s) 320 can be in data communication, via computer network 340, with one or more systems or servers of one or more financial institutions (e.g., financial institution(s) 360, a bank, a payment processor, etc.) to process the authorizations and/or declines of payment activities of various payment methods (e.g., credit card payments, debit or bank card payments, etc.). In some embodiments, back-end system(s) 320 further can process payments by store-issued gift cards and/or store credits (e.g., redeemed reward points, coupons, etc.), the associated accounts of which, including the respective balances, are stored in database(s) 330. In other examples, system 310 can include back-end system(s) 320, and vice versa.

In many embodiments, system 310 can generate a user interface portion for user device(s) 350. The user interface portion can be for one or more used payment methods (e.g., a credit card, an Electronic Benefits Transfer (EBT) card, a gift card, and/or a store-credit account, etc.) for an order payment by a user. To generate the user interface portion, system 310 can determining a payment method count for the user of the one or more used payment methods, and upon determining that the payment method count is greater than one (i.e., more than one payment methods are used for the order payment), system 310 further can determine a current payment method and generate a payment-method-selection area of the user interface portion. In a number of embodiments, the current payment method can be determined based on the one or more used payment methods and a payment-method-sequence rule. The payment-method-selection area generated can include one or more payment-method indications the one or more used payment methods. In many embodiments, each payment-method indication can include one or more of symbols, icons, and/or texts to show the account information. For example, a payment-method indication for a gift card can include a gift-card issuer's logo and a brief description: “Gift card ending in,” followed by the last 4 digits of the card number.

In several embodiments, the payment-method-sequence rule can include a sequence for displaying the one or more payment-method indications for the one or more used payment methods in the payment-method-selection area. For example, an exemplary sequence for one or more payment methods that system 300 accepts can be: a credit card (if used), an EBT card (if used), a debit/bank card (if used), a gift card (if used), and a store-credit account (if used). In similar or different embodiments, the payment-method-sequence rule further can include a respective sequence for displaying different accounts for each payment method of the one or more payment methods available. For example, the accounts can be sorted and displayed based on the last 4 digits of the account numbers. When the one or more payment methods for the order payment include a credit card and a gift card, the current payment method determined based on the exemplary payment-method-sequence rule can be the credit card used.

In a number of embodiments, the payment-method-selection area, as generated, can be configured to: receive, via the user device (e.g., user device(s) 350), a payment-method-display selection of the user for the current payment method from the one or more payment-method indications. The payment-method-selection area further can be configured to display a selected payment-method indication associated with the payment-method-display selection differently from one or more unselected payment-method indications of the one or more payment-method indications. For example, if the user selects by clicking the second payment-method indication (among three payment-method indications shown) on the payment-method-selection area, the second payment-method indication can be shown as a 3-dimensional button with highlight while the remaining payment-method indications each can be shown as a respective 2-dimensional grayed button.

In some embodiments, the payment-method-selection area further can be configured to, upon detecting a change in the payment-method-display selection of the user, cause a re-generation of the user interface portion. In many embodiments, the payment-method-display selection, by default when no payment-method-display selection is received or when no change in the payment-method-display selection is detected, can be the payment-method indication for the current payment method. If a change in the payment-method-display selection is detected, the payment method associated with the payment-method-display selection can become the current payment method.

In many embodiments, when an overall width of the one or more payment-method indications is greater than a width of the payment-method-selection area, the payment-method-selection area further can be configured to display the one or more payment-method indications in a multi-page configuration. In certain embodiments, each of the one or more payment-method indications can have the same width, and the payment-method-selection area in the multi-page configuration can include: (a) multiple pages, each configured to show a fixed count (e.g., 2, 2.5, 3⅓, etc.) of payment-method indications, and/or (b) one or more page changing controls (e.g., a scroll bar, a “back” button and/or a “next” button, texts page numbers associated with hyperlinks, or an area for receiving swiping motions on a touch screen, etc.) on each page.

In a number of embodiments, upon determining that the payment method count for the user of the one or more used payment methods is not greater than one (i.e., only one payment method is used for the order payment), the one or more used payment methods, which include only one payment method, can be used as the current payment method, and system 310 can either include a blank payment-method-selection area (e.g., showing nothing or an image with no payment-method indications at the location) or not include any payment-method-selection area in the user interface portion so the area can be used to show other information (e.g., a ledger area below).

In many embodiments, system 310 additionally can generate the ledger area of the user interface portion for the current payment method to display information associated with the current payment method and the order payment. The information can include payment-method-account information (e.g., the type of payment method used, the last 4 digits of the account number, etc.), a payment-method status (e.g., “temporary holds”, “initial charges”, “final charges”, etc.), and one or more activities associated with the current payment method (e.g., the respective title, status, amounts, and/or time for each activity, such as charges and/or refunds, for the orders and/or changes to one or more items of the order, the respective amounts, and/or the respective times). For example, when the current payment method is a MasterCard™ credit card, and when the order with 5 items is made but not yet shipped, the information displayed on the ledger area can include: (a) the payment-method-account information: “Mastercard ending in xxxx”; (b) the payment-method status: “Temporary holds”; and (c) an activity: “Temporary hold 10:03 AM $72.71”. In a similar example, if the user deletes an item from the order before shipping, the information displayed on the ledger area can include: (a) the payment-method-account information: “Mastercard ending in xxxx”; (b) the payment-method status: “Temporary holds”; and (c) 2 activities: “Temporary hold 10:03 AM $72.71” and “Order adjustment 2:45 PM-$5.49”. The one or more activities can be displayed in the ledger area chronologically or reverse chronologically.

In many embodiments, system 310 further can transmit, via a computer network (e.g., computer network 340), instructions to display a charge-history user interface comprising the user interface portion to be displayed on the user device (e.g., user device(s) 350) for the user. In a number of embodiments, the user interface portion can be configured to overlap the charge-history user interface when displayed on the user device. In some embodiments, the charge-history user interface further can include one or more other portions showing additional information. In similar or different embodiments, the charge-history user interface includes only the user interface portion and nothing else.

In certain embodiments, the charge-history user interface can be similar to, or can include similar information in, an order-detail user interface configured to display details for an order associated with the order payment (e.g., information about the order and/or the order payment, such as the items, the total amount, etc.), or vice versa. The charge-history user interface and/or the order-detail user interface can be generated by system 310. In many embodiments, the order-detail user interface further can include an entry point (e.g., a hyperlink or a button) configured to, when activated (e.g., clicked), cause a transmission of a request for the charge-history user interface for the order payment from user device(s) 350. After receiving the request for the charge-history user interface, system 310 further can generate the charge-history user interface, including the user interface portion for the one or more used payment methods.

Still referring to FIG. 3, in a number of embodiments, system 310 can generate the user interface portion further by, before determining the current payment method, determining the payment method count. In some embodiments, system 310 can be configured to show information about one or more used payment methods that are used for an order payment and have a positive balance and remove any payment methods that no longer have a positive balance from display. The payment method count thus can change according to the respective balance of each payment method used for an order payment becomes zero due to the cancellation of one or more items (by the user or the seller). In a few embodiments, system 310 can be configured to not show a used payment method with zero balance only when the used payment method is among one or more credit-based payment methods (e.g., credit card payments) and when the used payment method is settled (e.g., when the “temporary holds” status for the used payment method is lifted). That is, a user can still see non-credit-based payment methods, even if their balances are zero.

In some embodiments, to determine the payment method count, system 310 can retrieve, in real-time from a data storage (e.g., database(s) 330) or a server (e.g., back-end system(s) 320), one or more initial payment methods for the order payment. For each payment method of the initial payment methods, upon determining that (a) the each payment method is among one or more credit-based payment methods, (b) a respective payment-method status for the each payment method is settled, and (c) a respective final order amount associated with the each payment method and the order payment equals zero, system 310 further can update the one or more initial payment methods by removing the each payment method from the one or more initial payment methods.

If eventually system 310 determines that the one or more initial payment methods, as updated, is empty, system 310 can stop generating the user interface portion and not transmit the charge-history user interface to user device(s) 350 (e.g., by returning to the order-detail user interface or transmitting a user interface with an error message, etc.). Moreover, upon determining that the one or more initial payment methods, as updated, is not empty, system 310 can determine that the payment method count is a size of the one or more initial payment methods, as updated, and the one or more used payment methods can include the one or more initial payment methods, as updated.

In a number of embodiments, when system 310 determines that (a) each payment method of the one or more used payment methods is among one or more credit-based payment methods, (b) a respective payment-method status for the each payment method is settled, and (c) a respective final order amount associated with the each payment method and the order payment equals zero, system 310 also can either not generate or remove the entry point in/from the order-detail user interface.

Additionally, in many embodiments, to generate the ledger area of the user interface portion, system 310 can retrieve, in real-time from a data storage (e.g., database(s) 330) or a server (e.g., back-end system(s) 320), one or more account activities for the current payment method for the order payment, selectively determine the one or more activities from the one or more account activities based on the payment-method status, and incorporate for display the one or more activities on the ledger area. Examples of the payment-method status that affects how system 310 selectively determine the one or more activities can include one of more of the following. When (a) the payment-method status is pending, or (b) the current payment method is among one or more non-credit-based payment methods (e.g., EBD cards, gift cards, bank cards, etc.) and the payment-method status is final, the one or more activities can include the one or more account activities. When (a) the current payment method is among the one or more credit-based payment methods (e.g., credit cards), and (b) the payment-method status is final, the one or more activities can include the one or more account activities and a final order charge associated with the current payment method and the order payment. Further, when (a) the current payment method is among the one or more credit-based payment methods, and (b) the payment-method status is settled, the one or more activities can include the final order charge, and when the one or more account activities comprise a driver tip payment, the one or more activities further can include the driver tip payment. That is, in this situation (e.g., when credit card charges for the order and/or addition are settled), all of the prior temporary account activities (e.g., temporary holds or order adjustments) can be removed or hidden from the ledger area.

In a number of embodiments, to incorporate for display the one or more activities on the ledger area, system 310 further can arrange the one or more activities differently based on the payment-method status, the characteristics of the current payment method, and/or whether any additional post-transaction fee (e.g., an additional driver tip) is included in the one or more activities, etc. For example, upon determining that (a) the payment-method status is final, and (b) the current payment method is among the one or more credit-based payment methods: (i) upon determining that the one or more activities comprise a driver tip payment, system 310 can list the driver tip payment and the final order charge in a first region of the ledger area; (ii) upon determining that the one or more activities do not comprise the driver tip payment, system 310 further can list the final order charge in the first region of the ledger area; and (iii) system 310 additionally can list one or more remaining activities of the one or more activities reverse chronologically in a second region of the ledger area. The second region can be different from the first region.

In several embodiments, system 310 also can, upon determining that (a) the payment-method status is not final, or (b) the current payment method is among the one or more non-credit-based payment methods, list all of the one or more activities in the ledger area. In some embodiments, system 310 can list the one or more activities in the user interface portion in any suitable order or arrangement (e.g., chronologically, reverse chronologically, etc.) and/or allow the user to choose, via user device(s) 350, how to sort or filter the one or more activities in the ledger area.

In many embodiments, each of the one or more activities can be associated with a single one of activity types, such as a temporary hold, an order adjustment, an order charge, a refund, and an additional driver tip, etc. The temporary hold can be associated with unsettled credit-based payment activities, the order charge and the refund can be associated with non-credit-based payment activities, and the order adjustment and the additional driver tip can be associated with non-credit-based and/or credit-based payment activities. For example, when an activity is an unsettled payment activity for the order payment by a credit-based payment method (e.g., a credit card), the activity can be associated with the activity type of either the temporary hold or the order adjustment. When an activity is a payment activity for the order payment by a non-credit-based payment method (e.g., an EBT or gift card), the activity is associated with the activity type of either the order charge or the refund.

In several embodiments, to enhance the user's understanding of the payment activities, system 310 further can incorporate for display, on the ledger area, (a) one or more payment-related descriptions; and/or (b) one or more information entry points each configured to, when activated, cause a display of a respective pop-up window showing respective information. The descriptions to be displayed on the ledger area and/or the information to be shown on a pop-up window can be associated with each associated with the current payment method, the payment-method status, and/or a respective account activity of the one or more activities, etc.

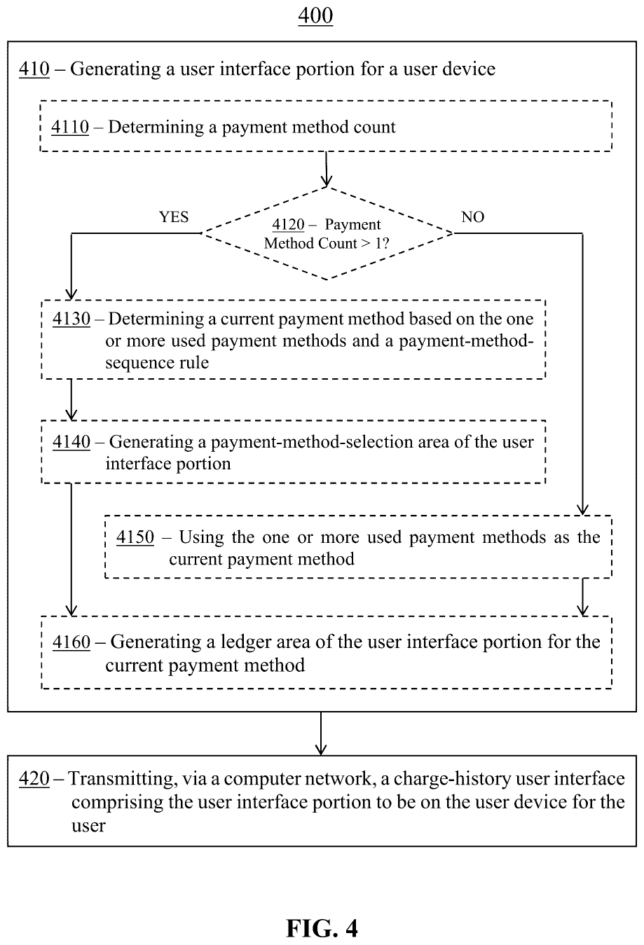

Turning ahead in the drawings, FIG. 4 illustrates a flow chart for a method 400 of generating a user interface portion for a user device for displaying payment activities, according to an embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3) or system 310 (FIG. 3) can be suitable to perform method 400 and/or one or more of the procedures, the processes, and/or the activities of method 400. In these or other embodiments, one or more of the procedures, the processes, and/or the activities of method 400 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

Referring to FIG. 4, in many embodiments, method 400 can include a block 410 of generating a user interface portion for a user device (e.g., user device(s) 350 (FIG. 3)). The user interface portion can be configured to show payment activities for one or more used payment methods for an order payment by a user. In the user interface portion, the payment activities can be grouped based on the one or more used payment methods. In certain embodiments, the user interface portion can display one or more activities for a single used payment method (e.g., a current payment method) of the one or more used payment methods and hide the other payment activities for the remaining used payment method(s). This approach is advantageous because it would be easier for the user to match the one or more activities for the current payment method shown on the user interface portion with the transactions shown on the user's account statement. In different embodiments, block 410 can display all of payment activities associated with the order payment in any suitable fashion (e.g., chronologically or reverse chronologically, sorted based on the respective amount associated with each payment activity, etc.).

In a number of embodiments, block 410 can include a block 4110 of determining a payment method count for the user of the one or more used payment methods. The one or more used payment methods can be selected by the user from the one or more available payment methods for the user (e.g., the credit or debit card accounts associated with the user account for the user and stored in a database (e.g., database(s) 330 (FIG. 3)) to split the total amount for the order payment (e.g., split evenly based on the total amount or based on items, etc.).

In some embodiments, the payment method count can be dynamic, determined based on the characteristics (e.g., cash based or not), the respective status (e.g., “temporary hold”, “refund”, “order charge”, etc.), and/or the respective amount of each payment method. For example, if one or more used payment methods for an order payment include a credit card, an EBT card, and a gift card when the user submits an order at an online retail website, the payment method count can be the size of the one or more used payment methods (i.e., 3 here) initially. Then, before the order is delivered, the user cancels an item from the order, and the refund is deducted from the total charge of a refund payment method of the one or more used payment methods (e.g., either pursuant to the user's choice or automatically decided by the online retailer's system). When: (a) the refund payment method is credit-based (e.g., the credit card used here), (b) the total charge for the refund payment method becomes zero as a result of the refund, and (c) the payment-method status for the refund payment method is settled (e.g., 10 days after the order is delivered and the order payment becomes final), the refund payment method can be removed from the one or more used payment methods, and the payment method count can become the size of the one or more used payment methods, as updated.

In a number of embodiments, block 410 further can include a block 4120 of determining whether the payment method count, as determined in block 4110, is greater than one. Upon determining in block 4110 that the payment method count is greater than one, block 410 can further include a block 4130 of determining a current payment method based on the one or more used payment methods and a payment-method-sequence rule. An exemplary payment-method-sequence rule can include a predetermined sequence for displaying one or more payment methods the online retail system accepts.

In some embodiments, block 410 also can include a block 4140 of generating a payment-method-selection area of the user interface portion, after determining the current payment method in block 4130. The payment-method-selection area can include one or more payment-method indications for the one or more used payment methods and can receive, via the user device (e.g., user device(s) 350 (FIG. 3)), a payment-method-display selection of the user for the current payment method from the one or more payment-method indications. The payment-method-selection area further can be configured to, upon detecting a change in the payment-method-display selection of the user, cause a re-generation of the user interface portion in block 410.

In certain embodiments, the payment-method-selection area, as generated in block 4140, can be configured to display the one or more payment-method indications in a multi-page configuration when an overall width of the one or more payment-method indications is greater than a width of the payment-method-selection area. The payment-method-selection area further can be configured to display a selected payment-method indication associated with the payment-method-display selection differently from one or more unselected payment-method indications of the one or more payment-method indications.

In a number of embodiments, upon determining in block 4120 that the payment method count equals one (e.g., not greater than one), block 410 further can include 4150 of using the one or more used payment methods as the current payment method.

In many embodiments, block 410 additionally can include a block 4160 of generating a ledger area of the user interface portion for the current payment method, as determined in block 4130 or 4150. The ledger area can be configured to display information associated with the current payment method and the order payment. The information can include payment-method-account information (e.g., a type and/or an account identifier (e.g., the account number or the nickname) of the current payment method), a payment-method status (e.g., “initial charges,” “final charges,” “temporary holds,” etc.), and/or one or more activities (e.g., payment activities for the initial order payment, any changes to the ordered item(s), and/or any additional tip) associated with the current payment method.

In a number of embodiments, block 4160 can include retrieving, in real-time from a data storage (e.g., database(s) 330 (FIG. 3)) or a server (e.g., system 300 (FIG. 3) or back-end system(s) 320 (FIG. 3)), one or more account activities for the current payment method for the order payment. In certain embodiments, not all of the one or more account activities are to be displayed in the ledger area. In several embodiments, the ledger area further can include information about an additional item or activity (e.g., a final order charge or a balance of the current payment method and/or an additional driver tip for the order), which is associated with, but forms not part of, the order payment. Block 4610 further can include selectively determining the one or more activities from the one or more account activities based on the payment-method status. In similar or different embodiments, the one or more activities can include all of the one or more account activities. Block 4610 additionally can include incorporating for display the one or more activities, as determined, on the ledger area.

In several embodiments, the ledger area, as generated in block 4160, can include a first region (e.g., the top or the left side) and a second region (e.g., the bottom or the right side). The first region can include the driver tip payment, if any, and the final order charge for the current payment method listed or shown, and the second region can include one or more remaining activities of the one or more activities listed reverse chronologically.

In a number of embodiments, method 400 further can include a block 420 of transmitting, via a computer network (e.g., computer network 340 (FIG. 3)), a charge-history user interface comprising the user interface portion to be on the user device (e.g., user device(s) 350 (FIG. 3)) for the user. In a few embodiments, the user interface portion can be configured to overlap the charge-history user interface when displayed on the user device.

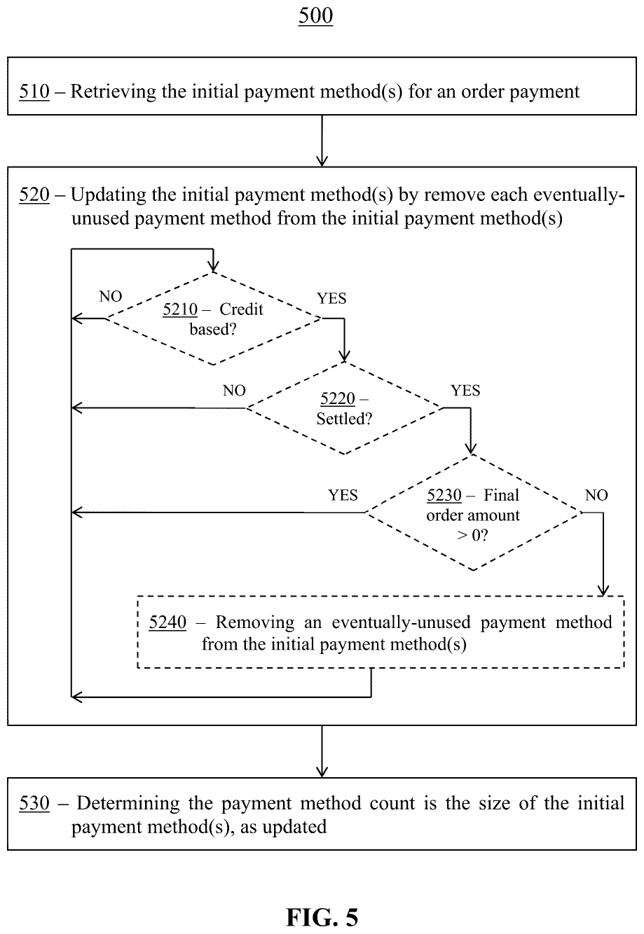

Turning ahead in the drawings, FIG. 5 illustrates a flow chart for a method 500 of determining a payment method count for the one or more payment methods used for an order payment, according to an embodiment. Method 500 is merely exemplary and is not limited to the embodiments presented herein. Method 500 can be employed in many different embodiments or examples not specifically depicted or described herein. For example, method 500 can be adopted in method 400 (FIG. 4) or block 4110 (FIG. 4). In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, system 300 (FIG. 3) or system 310 (FIG. 3) can be suitable to perform method 500 and/or one or more of the procedures, the processes, and/or the activities of method 500. In these or other embodiments, one or more of the procedures, the processes, and/or the activities of method 500 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1). Furthermore, in a number of embodiments, method 500 can include one or more procedures, processes, or activities in method 400 (FIG. 4).

In a number of embodiments, method 500 can include a block 510 of retrieving one or more initial payment methods for an order payment. Method 500 further can include a block 520 of updating the one or more initial payment methods by removing each eventually-unused payment method from the one or more initial payment methods, as retrieved in block 510. In many embodiments, block 520 can include one or more procedures, processes, and/or activities to determine whether each payment method of the one or more initial payment methods is an eventually-unused payment method. In an embodiment shown in FIG. 5, block 520 can include a block 5210 of determining whether the payment method is non-credit-based. If the payment method is not cashed-based, as determined in block 5210, block 520 further can include a block 5220 of determining whether the payment method is settled. When the payment method is settled, as determined in block 5220, block 520 further can include a block 5230 of determining whether the final order amount for the payment method is positive. Upon determining that the final order amount is greater than zero, as determined in block 5230, block 520 further can determine that the payment method is an eventually-unused payment method. Then, block 520 further include a block 5240 of removing the payment method, as determined as an eventually-unused payment method, from the one or more initial payment methods.

In many embodiments, method 500 further can include a block 530 of determining that the payment method count is the size of the one or more initial payment methods, as updated in block 520.

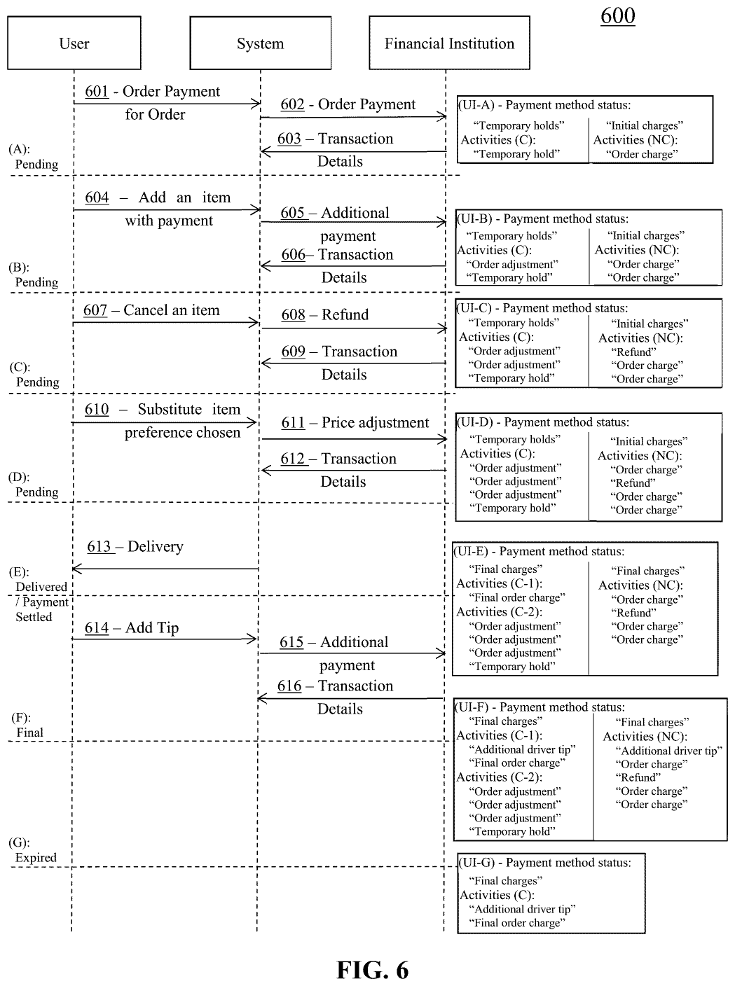

Turning ahead in the drawings, FIG. 6 illustrates a time series chart 600 of events of an exemplary order payment, according to an embodiment. Chart 600 is merely exemplary and is not limited to the embodiments presented herein. Chart 600 can be employed in many different embodiments or examples not specifically depicted or described herein. In some embodiments, the events of chart 600 can be caused to occur in the order presented. In other embodiments, the events of chart 600 can be caused to occur in any suitable order. In still other embodiments, one or more of the events of chart 600 can be skipped.

In many embodiments, system 300 (FIG. 3), system 310 (FIG. 3), or method 400 (FIG. 4) can be suitable to facilitate the events of chart 600 and/or one or more of the events of chart 600. In these or other embodiments, one or more of the events of chart 600 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

Referring to FIG. 6, the events in chart 600 can be grouped into stages A-G based on the nature of the events. In a number of embodiments, at stage A when the order is pending, chart 600 can include an event 601 of a user submitting, from a user device (e.g., user device(s) 350 (FIG. 3)) via a computer network (e.g., computer network 340 (FIG. 3)), an authorization of an order payment for an order to a system (e.g., system 300 (FIG. 3)). The authorization of the order payment can include one or more initial payment methods and the respective amounts for each of the payment methods. In some embodiments, upon receiving the order payment authorization in event 601, chart 600 further can include an event 602 of the system requesting, via the computer network, the order payment from a financial institution (e.g., financial institution(s) 360 (FIG. 3)). Then, chart 600 additionally can include an event 603 of the financial institution responding, in real-time via the computer network, with transaction details associated with the order payment. In certain embodiments, the transaction details can include the respective status of each of the one or more initial payment methods.

In some embodiments, at the end of stage A, per the user's request or voluntarily reporting by the system, a user interface (or at least a portion thereof) (see, e.g., UI-A) can be generated by system 300 (FIG. 3), system 310 (FIG. 3), or method 400 (FIG. 4) and transmitted to the user device to show the one or more payment activities and payment method status of a current payment method of the one or more initial payment methods. For example, in an embodiment, when the current payment method is a credit-based payment method (e.g., a credit card), the ledger area of a user interface portion of the user interface, as generated at the end of stage A, can include the payment method status of “temporary holds”, while the activities (e.g., Activities (C)) can include a “temporary hold” item followed by the amount and/or other information (not shown here). If the current payment method is a non-credit-based payment method (e.g., an EBT card), the ledger area of a user interface portion of the user interface, as generated at the end of stage A, can include the payment method status of “initial charges”, while the activities (e.g., Activities (NC), shown reverse chronologically) can include an “order charge” item followed by the amount and/or other information also not shown here).

In a number of embodiments, at stage B when the order is still pending, chart 600 can include an event 604 of a user adding, from the user device via a computer network, an item to the pending order and authorizing an additional payment. In a few embodiments, upon receiving the user input in event 604, chart 600 further can include an event 605 of the system requesting, via the computer network, the additional payment from the financial institution. Then, chart 600 additionally can include an event 606 of the financial institution responding, in real-time via the computer network, with another transaction details associated with the additional payment.

In some embodiments, at the end of stage B (after event 606), a user interface (or at least a portion thereof) (see, e.g., UI-B) can be generated by system 300 (FIG. 3), system 310 (FIG. 3), or method 400 (FIG. 4) and transmitted to the user device to show the one or more payment activities and payment method status of the current payment method. For example, in several embodiments, when the current payment method is a credit-based payment method, the ledger area of a user interface portion of the user interface, as generated at the end of stage B, can include the payment method status of “temporary holds”, while the activities (e.g., Activities (C)) can include an “order adjustment” item for the additional payment and one or more prior activities (e.g., the “temporary hold” item in stage A), each followed by the respective amount and/or other information (not shown here). If the current payment method is a non-credit-based payment method, the ledger area, as generated at the end of stage B, can include the payment method status of “initial charges”, while the activities (e.g., Activities (NC)) can include an “order charge” item for the additional payment and the one or more prior activities (e.g., a second “order charge” item for the initial order payment at stage A).

In a number of embodiments, at stage C when the order is still pending, chart 600 can include an event 607 of a user cancelling, using the user device via a computer network, an item from the pending order and requesting a refund. In a few embodiments, upon receiving the user input in event 607, chart 600 further can include an event 608 of the system requesting, via the computer network, a refund (or an equivalent activity) from the financial institution. Then, chart 600 additionally can include an event 609 of the financial institution responding, in real-time via the computer network, with another transaction details associated with the refund.

In some embodiments, at the end of stage C (after event 609), a user interface (or at least a portion thereof) (see, e.g., UI-C) can be generated by system 300 (FIG. 3), system 310 (FIG. 3), or method 400 (FIG. 4) and transmitted to the user device to show the one or more payment activities and payment method status of the current payment method. For example, in several embodiments, when the current payment method is a credit-based payment method, the ledger area of a user interface portion of the user interface, as generated at the end of stage C, can include the payment method status of “temporary holds,” while the activities (e.g., Activities (C)) can include an “order adjustment” item for the cancellation and the one or more prior activities (e.g., the items at stages A and B). If the current payment method is a non-credit-based payment method, the ledger area, as generated at the end of stage C, can include the payment method status of “initial charges”, while the activities (e.g., Activities (NC)) can include an “order charge” item for the cancellation and the one or more prior activities.

In a number of embodiments, at stage D when the order is still pending, chart 600 can include an event 610 of the user choosing, via the user device via the computer network, a substitute item preference. In certain embodiments, upon receiving the input in event 610, chart 600 further can include an event 611 of the system automatically determining a substitute item in the pending order based on the user's substitute item preference and requesting, via the computer network, the change in charge, if any, for the substitution from the financial institution. Then, chart 600 additionally can include an event 612 of the financial institution responding, in real-time via the computer network, with another transaction details associated with the refund.

In some embodiments, at the end of stage D (after event 612), a user interface (or at least a portion thereof) (see, e.g., UI-D) can be generated by system 300 (FIG. 3), system 310 (FIG. 3), or method 400 (FIG. 4) and transmitted to the user device to show the one or more payment activities and payment method status of the current payment method. For example, in several embodiments, when the current payment method is a credit-based payment method, the ledger area, as generated at the end of stage D, can include the payment method status of “temporary holds,” while the activities (e.g., Activities (C)) can include an “order adjustment” item for a price difference (when the price of the substitute item is different from the price of the original item) and the one or more prior activities (e.g., the items at stages A, B, and C). If the current payment method is a non-credit-based payment method, the ledger area, as generated at the end of stage D, can include the payment method status of “initial charges”, while the activities (e.g., Activities (NC)) can include a new “order charge” item for the price difference (when the price of the substitute item is greater than the price of the original item) and the one or more prior activities. In certain embodiments, the system would not create a new charge for the substitution if the price difference is within a predetermined threshold (e.g., 1 dollar, 2.5 dollars, etc.).

In a number of embodiments, at stage E, chart 600 can include an event 613 of the system facilitating the delivery of the order by using a delivery driver network, or a delivery driver, etc. (or allowing the pickup of the order). In some embodiments, at the end of stage E (after event 613), the order is final, and a user interface (or at least a portion thereof) (see, e.g., UI-E) can be generated by system 300 (FIG. 3), system 310 (FIG. 3), or method 400 (FIG. 4) and transmitted to the user device to show the one or more payment activities and payment method status of the current payment method. For example, in several embodiments, when the current payment method is a credit-based payment method, the ledger area, as generated at the end of stage E, can include the payment method status of “final charges,” while the activities (e.g., Activities (C)) can be categorized into 2 groups. The first group of activities can include a “final order charge” item followed by the total amount (not shown), displayed on a first region of the ledger area, and the second group of activities can include the one or more prior activities (e.g., the items at stages A, B, C, and D). If the current payment method is a non-credit-based payment method, the ledger area, as generated at the end of stage D, can include the one or more prior activities (e.g., the items at stages A, B, C, and D).

In a number of embodiments, at stage F after the order is delivered, chart 600 can include an event 614 of the user authorizing, from the user interface via the computer network, an additional tip. In many embodiments, the system can allow the user to tip the driver only by some payment methods (e.g., credit cards and debit cards), but not others (e.g., EBT cards, gift cards, etc.). In several embodiments, upon receiving the user input in event 614, chart 600 further can include an event 615 of the system requesting, via the computer network, the additional payment for the tip from the financial institution. Then, chart 600 additionally can include an event 616 of the financial institution responding, in real-time via the computer network, with another transaction details associated with the refund.

In a few embodiments, at the end of stage F, a user interface (or at least a portion thereof) (see, e.g., UI-F) can be generated by system 300 (FIG. 3), system 310 (FIG. 3), or method 400 (FIG. 4) and transmitted to the user device to show the one or more payment activities and payment method status of the current payment method. For example, in several embodiments, when the current payment method is a credit-based payment method used for paying the tip, the ledger area, as generated at the end of stage F, can include the payment method status of “final charges,” while the activities (e.g., Activities (C)) can be categorized into 2 groups. The first group of activities can include an “additional driver tip” item and the “final order charge” item, as generated in stage E, displayed on the first region of the ledger area, and the second group of activities can include the one or more prior activities (e.g., the items at stages A, B, C, and D), before the order payment is “final.” If the current payment method is a non-credit-based payment method used for paying the tip (e.g., a debit card), the ledger area, as generated at the end of stage F, can include an “additional driver tip” item and the one or more prior activities (e.g., the items at stages A, B, C, and D). In many embodiments, from this stage (F), the payment via the non-credit-based payment method is final, and there can be no more new activities for the non-credit-based payment method. (If no additional tip is given, the payment can be final at stage E.) As to the credit-based payment method, it generally would take days before the fund is settled (e.g., the system receives the payment from the financial institution), and the “temporary holds” status thus can remain for several days.

In a number of embodiments, at stage G, chart 600 further can include a time period the temporary holds of the order payment expires. The time period can be predetermined and fixed (e.g., 3 days, 5 days, 10 days, etc.) or be determined by any suitable event (e.g., the system receives the payment or a notification about the release). At the end of stage G, a user interface (or at least a portion thereof) (see, e.g., UI-G) can be generated by system 300 (FIG. 3), system 310 (FIG. 3), or method 400 (FIG. 4) and transmitted to the user device to show a final listing of the payment activities. For example, in several embodiments, when the current payment method is a credit-based payment method, the ledger area, as generated at the end of stage G, can include the payment method status of “final charges,” while the activities (e.g., Activities (C)) can include the “additional driver tip” item and the “final order charge” item, as generated in stage F, without the temporary items. As to the non-credit-based payment method as the current payment method, as stated above, the payment activities are final at no later than stage F, and information to be displayed in the ledger area is omitted here.

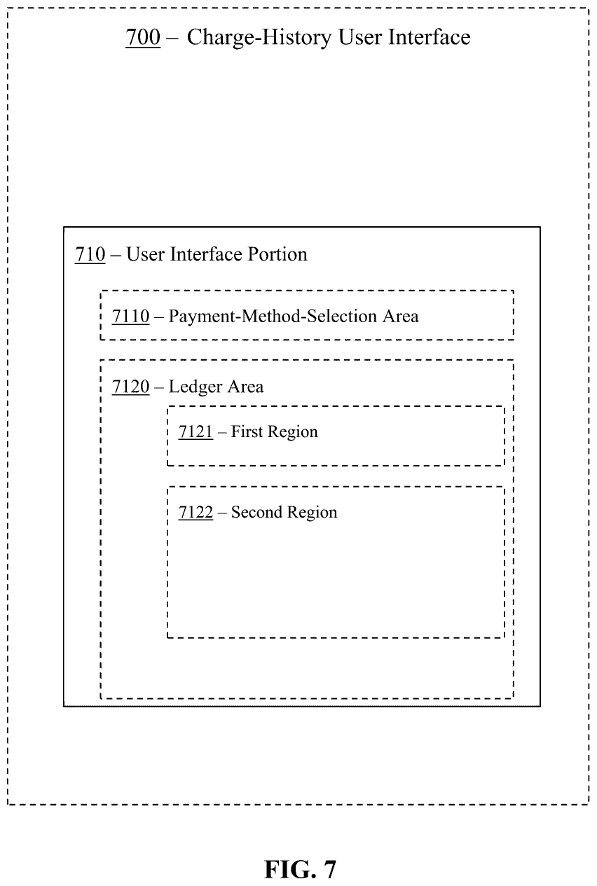

Turning ahead in the drawings, FIG. 7 illustrates an exemplary layout of a charge-history user interface 700 with a user interface portion 710 for displaying payment activities, according to an embodiment. Charge-history user interface 700 is merely exemplary and is not limited to the embodiments presented herein. Charge-history user interface 700 can be employed in many different embodiments or examples not specifically depicted or described herein. In some embodiments, the user interface portions, the areas, and/or the components of charge-history user interface 700 can be arranged in the layout presented. In other embodiments, the user interface portions, the areas, and/or the components of charge-history user interface 700 can be arranged in any suitable layouts. In still other embodiments, one or more of the user interface portions, the areas, and/or the components of charge-history user interface 700 can be combined or omitted. In many embodiments, system 300 (FIG. 3), system 310 (FIG. 3), method 400 (FIG. 4), or method 500 (FIG. 5) can be suitable to generate charge-history user interface 700 and/or one or more of the user interface portions, the areas, and/or the components of charge-history user interface 700.

Referring to FIG. 7, in a number of embodiments, charge-history user interface 700 can include a user interface portion 710 similar or identical to the user interface portions discussed above. User interface portion 710 can include a payment-method-selection area 7110 and a ledger area 7120. Payment-method-selection area 7110 can be similar or identical to the payment-method-selection areas discussed above (see, e.g., block 4140 (FIG. 4)), and ledger area 7120 can be similar or identical to the ledger areas discussed above (e.g., block 4160 (FIG. 4)). In certain embodiments, user interface portion 710 can be configured to hide or remove payment-method-selection area 7110 when a payment method count for one or more used payment methods for an order payment is not greater than one.

In some embodiments, ledger area 7120 can include a first region 7121 and a second region 7122. First region 7121 can be configured to show a final order charge and an additional driver tip, if any, for the current payment method and the order payment. Second region 7122 can be configured to show one or more remaining activities for the current payment method and the order payment. In similar or different embodiments, there can be no first region 7121 or second region 7122 in ledger area 7120, and ledger area 7120 can display information associated with the current payment method and the order payment directly.

Various embodiments additionally can include a system for generating a user interface portion for displaying payment activities. The system can include one or more processors and one or more non-transitory computer-readable media storing computing instructions configured to, when run on the one or more processors, cause the one or more processors to perform one or more acts. The one or more acts can include generating a user interface portion for a user device. The user interface portion can be for one or more used payment methods for an order payment by a user.

In a number of embodiments, the act of generating the user interface portion can include upon determining that a payment method count for the user of the one or more used payment methods is greater than one, determining a current payment method based on the one or more used payment methods and a payment-method-sequence rule. The act of generating the user interface portion further can include generating a payment-method-selection area of the user interface portion. The payment-method-selection area, as generated, can include one or more payment-method indications for the one or more used payment methods. The payment-method-selection area further can be configured to (a) receive, via the user device, a payment-method-display selection of the user for the current payment method from the one or more payment-method indications, and (b) upon detecting a change in the payment-method-display selection of the user, cause a re-generation of the user interface portion.

In some embodiments, when an overall width of the one or more payment-method indications is greater than a width of the payment-method-selection area, the payment-method-selection area can be further configured to display the one or more payment-method indications in a multi-page configuration. In several embodiments, the payment-method-selection area also can be further configured to display a selected payment-method indication associated with the payment-method-display selection differently from one or more unselected payment-method indications of the one or more payment-method indications.

In many embodiments, the act of generating the user interface portion further can include: upon determining that the payment method count for the user of the one or more used payment methods is not greater than one, using the one or more used payment methods as the current payment method. In a number of embodiments, the act of generating the user interface portion further can include generating a ledger area of the user interface portion for the current payment method to display information associated with the current payment method and the order payment. The information can include payment-method-account information, a payment-method status, and one or more activities associated with the current payment method.

In many embodiments, the one or more acts additionally can include transmitting, via a computer network, instructions to display a charge-history user interface comprising the user interface portion to be displayed on the user device for the user. The user interface portion can be configured to overlap the charge-history user interface when displayed on the user device.

In a number of embodiments, the act of generating the user interface portion further can include, before determining the current payment method, determining the payment method count by: (i) retrieving, in real-time from a data storage or a server, one or more initial payment methods for the order payment; (ii) for each payment method of the initial payment methods, upon determining that (a) the each payment method is among one or more credit-based payment methods, (b) a respective payment-method status for the each payment method is settled, and (c) a respective final order amount associated with the each payment method and the order payment equals zero, updating the one or more initial payment methods by removing the each payment method from the one or more initial payment methods; (iii) upon determining that the one or more initial payment methods, as updated, is empty, stopping generating the user interface portion; and (iv) upon determining that the one or more initial payment methods, as updated, is not empty: (a) determining that the payment method count is a size of the one or more initial payment methods, as updated; and (b) the one or more used payment methods comprise the one or more initial payment methods, as updated.

In several embodiments, the act of generating the ledger area of the user interface portion can include: (a) retrieving, in real-time from a data storage or a server, one or more account activities for the current payment method for the order payment; (b) selectively determining the one or more activities from the one or more account activities based on the payment-method status; and (c) incorporating for display the one or more activities on the ledger area. In certain embodiments, when (a) the payment-method status is pending, or (b) the current payment method is among one or more non-credit-based payment methods and the payment-method status is final, the one or more activities can include the one or more account activities. In a few embodiments, when (a) the current payment method is among the one or more credit-based payment methods, and (b) the payment-method status is final, the one or more activities can include the one or more account activities and a final order charge associated with the current payment method and the order payment. In some embodiments, when (a) the current payment method is among the one or more credit-based payment methods, and (b) the payment-method status is settled: the one or more activities can include the final order charge, and when the one or more account activities comprise a driver tip payment, the one or more activities further can include the driver tip payment.

In a number of embodiments, the act of incorporating for display the one or more activities can include upon determining that (a) the payment-method status is final, and (b) the current payment method is among the one or more credit-based payment methods: upon determining that the one or more activities comprise the driver tip payment, listing the driver tip payment and the final order charge in a first region of the ledger area; upon determining that the one or more activities do not comprise the driver tip payment, listing the final order charge in the first region of the ledger area; and listing one or more remaining activities of the one or more activities reverse chronologically in a second region of the ledger area. In some embodiments, the act of incorporating for display the one or more activities further can include upon determining that (a) the payment-method status is not final, or (b) the current payment method is among the one or more non-credit-based payment methods, listing the one or more activities reverse chronologically in the ledger area.

In a number of embodiments, each of the one or more activities can be associated with a single one of activity types comprising a temporary hold, an order adjustment, an order charge, a refund, and an additional driver tip. The temporary hold and the order adjustment can be associated with unsettled credit-based payment activities, and the order charge and the refund can be associated with non-credit-based payment activities.

In some embodiments, the act of generating the user interface portion further can include incorporating for display, on the ledger area, (a) one or more payment-related descriptions each associated with one or more of: the current payment method, the payment-method status, or a first respective account activity of the one or more activities; and/or (b) one or more information entry points each configured to, when activated, cause a display of a respective pop-up window showing respective information associated with one or more of: the current payment method, the payment-method status, or a second respective account activity of the one or more activities.

In a number of embodiments, the one or more acts further can include: before generating the user interface portion, generating an order-detail user interface configured to display details for an order associated with the order payment and an entry point. The entry point can be configured to, when activated, cause a transmission of a request for the charge-history user interface for the order payment from the user device. The act of generating the user interface portion further can include upon receiving the request, generating the user interface portion of the charge-history user interface for the one or more used payment methods. In several embodiments, the act of generating the order-detail user interface further can include upon determining that (a) each payment method of the one or more used payment methods is among one or more credit-based payment methods, (b) a respective payment-method status for the each payment method is settled, and (c) a respective final order amount associated with the each payment method and the order payment equals zero, removing the entry point from the order-detail user interface.

Various embodiments also can include a method for generating a user interface portion for a user device for displaying payment activities. The method can be implemented via execution of computing instructions configured to run at one or more processors and stored at one or more non-transitory computer-readable media. The method can include one or more of the one or more acts described above. For example, the method can include generating a user interface portion for a user device. The user interface portion can be for one or more used payment methods for an order payment by a user.

In a number of embodiments, generating the user interface portion can include upon determining that a payment method count for the user of the one or more used payment methods is greater than one: (a) determining a current payment method based on the one or more used payment methods and a payment-method-sequence rule; and (b) generating the user interface portion further can include generating a payment-method-selection area of the user interface portion. The payment-method-selection area, as generated, can include one or more payment-method indications for the one or more used payment methods. The payment-method-selection area further can be configured to (a) receive, via the user device, a payment-method-display selection of the user for the current payment method from the one or more payment-method indications, and (b) upon detecting a change in the payment-method-display selection of the user, cause a re-generation of the user interface portion.

In many embodiments, generating the user interface portion further can include: upon determining that the payment method count for the user of the one or more used payment methods is not greater than one, using the one or more used payment methods as the current payment method. In a number of embodiments, generating the user interface portion additionally can include generating a ledger area of the user interface portion for the current payment method to display information associated with the current payment method and the order payment. The information can include payment-method-account information, a payment-method status, and one or more activities associated with the current payment method.

In some embodiments, the method further can include transmitting, via a computer network, instructions to display a charge-history user interface comprising the user interface portion to be displayed on the user device for the user.

In many embodiments, the techniques described herein can provide a practical application and several technological improvements. In some embodiments, the techniques described herein can provide improved approaches for generating user interface portions for a user device for displaying payment activities. In a number of embodiments, the techniques described herein can solve a technical problem that arises only within the realm of computer environment, as user interfaces do not exist outside the realm of computer systems.

Although generating a user interface portion for a user device has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIGS. 4-5 may include different procedures, processes, and/or activities and be performed by many different systems, in many different orders. As another example, the modules, models, and/or systems within system 300 or system 310 in FIG. 3 or used in method 400 in FIG. 4 or method 500 in FIG. 5 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to, when run on the one or more processors, cause the one or more processors to perform:
generating a user interface portion for a user device, wherein the user interface portion is for one or more used payment methods for an order payment by a user, comprising:
upon determining that a payment method count for the user of the one or more used payment methods is greater than one:
determining a current payment method based on the one or more used payment methods and a payment-method-sequence rule; and
generating a payment-method-selection area of the user interface portion, the payment-method-selection area comprising one or more payment-method indications for the one or more used payment methods, wherein:
the payment-method-selection area is configured to:
receive, via the user device, a payment-method-display selection of the user for the current payment method from the one or more payment-method indications; and
upon detecting a change in the payment-method-display selection of the user, cause a re-generation of the user interface portion;
upon determining that the payment method count for the user of the one or more used payment methods is not greater than one, using the one or more used payment methods as the current payment method; and
generating a ledger area of the user interface portion for the current payment method to display information associated with the current payment method and the order payment, the information comprising:
payment-method-account information;
a payment-method status; and
one or more activities associated with the current payment method; and
transmitting, via a computer network, instructions to display a charge-history user interface comprising the user interface portion to be displayed on the user device for the user.

2. The system in claim 1, wherein one or more of:
when an overall width of the one or more payment-method indications is greater than a width of the payment-method-selection area, the payment-method-selection area is further configured to display the one or more payment-method indications in a multi-page configuration;
the payment-method-selection area is further configured to display a selected payment-method indication associated with the payment-method-display selection differently from one or more unselected payment-method indications of the one or more payment-method indications; or
the user interface portion is configured to overlap the charge-history user interface when displayed on the user device.

3. The system in claim 1, wherein generating the user interface portion further comprises, before determining the current payment method, determining the payment method count by:
retrieving, in real-time from a data storage or a server, one or more initial payment methods for the order payment;
for each payment method of the initial payment methods, upon determining that (a) the each payment method is among one or more credit-based payment methods, (b) a respective payment-method status for the each payment method is settled, and (c) a respective final order amount associated with the each payment method and the order payment equals zero, updating the one or more initial payment methods by removing the each payment method from the one or more initial payment methods;
upon determining that the one or more initial payment methods, as updated, is empty, stopping generating the user interface portion; and
upon determining that the one or more initial payment methods, as updated, is not empty:
determining that the payment method count is a size of the one or more initial payment methods, as updated; and
the one or more used payment methods comprise the one or more initial payment methods, as updated.

4. The system in claim 1, wherein generating the ledger area of the user interface portion comprises:
retrieving, in real-time from a data storage or a server, one or more account activities for the current payment method for the order payment;
selectively determining the one or more activities from the one or more account activities based on the payment-method status, wherein one or more of:
when (a) the payment-method status is pending, or (b) the current payment method is among one or more non-credit-based payment methods and the payment-method status is final, the one or more activities comprise the one or more account activities;
when (a) the current payment method is among the one or more credit-based payment methods, and (b) the payment-method status is final, the one or more activities comprise the one or more account activities and a final order charge associated with the current payment method and the order payment; or
when (a) the current payment method is among the one or more credit-based payment methods, and (b) the payment-method status is settled:
the one or more activities comprise the final order charge; and
when the one or more account activities comprise a driver tip payment, the one or more activities further comprises the driver tip payment; and
incorporating for display the one or more activities on the ledger area.

5. The system in claim 4, wherein incorporating for display the one or more activities comprises:
upon determining that (a) the payment-method status is final, and (b) the current payment method is among the one or more credit-based payment methods:
upon determining that the one or more activities comprise the driver tip payment, listing the driver tip payment and the final order charge in a first region of the ledger area;
upon determining that the one or more activities do not comprise the driver tip payment, listing the final order charge in the first region of the ledger area; and
listing one or more remaining activities of the one or more activities reverse chronologically in a second region of the ledger area; and
upon determining that (a) the payment-method status is not final, or (b) the current payment method is among the one or more non-credit-based payment methods, listing the one or more activities reverse chronologically in the ledger area.

6. The system in claim 1, wherein each of the one or more activities is associated with a single one of activity types comprising a temporary hold, an order adjustment, an order charge, a refund, and an additional driver tip.

7. The system in claim 6, wherein:
the temporary hold and the order adjustment are associated with unsettled credit-based payment activities; and
the order charge and the refund are associated with non-credit-based payment activities.

8. The system in claim 1, wherein generating the user interface portion further comprises incorporating for display, on the ledger area, one or more of:
one or more payment-related descriptions each associated with one or more of: the current payment method, the payment-method status, or a first respective account activity of the one or more activities; or
one or more information entry points each configured to, when activated, cause a display of a respective pop-up window showing respective information associated with one or more of: the current payment method, the payment-method status, or a second respective account activity of the one or more activities.

9. The system in claim 1, wherein the computing instructions are further configured, when run on the one or more processors, to cause the one or more processors to perform:
before generating the user interface portion, generating an order-detail user interface configured to display details for an order associated with the order payment and an entry point, wherein:
the entry point is configured to, when activated, cause a transmission of a request for the charge-history user interface for the order payment from the user device; and
generating the user interface portion further comprises upon receiving the request, generating the user interface portion of the charge-history user interface for the one or more used payment methods.

10. The system in claim 9, wherein generating the order-detail user interface further comprises:
upon determining that (a) each payment method of the one or more used payment methods is among one or more credit-based payment methods, (b) a respective payment-method status for the each payment method is settled, and (c) a respective final order amount associated with the each payment method and the order payment equals zero, removing the entry point from the order-detail user interface.

11. A method being implemented via execution of computing instructions configured to run at one or more processors and stored at one or more non-transitory computer-readable media, the method comprising:
generating a user interface portion for a user device, wherein the user interface portion is for one or more used payment methods for an order payment by a user, comprising:
upon determining that a payment method count for the user of the one or more used payment methods is greater than one:
determining a current payment method based on the one or more used payment methods and a payment-method-sequence rule; and
generating a payment-method-selection area of the user interface portion, the payment-method-selection area comprising one or more payment-method indications for the one or more used payment methods, wherein:
the payment-method-selection area is configured to:
receive, via the user device, a payment-method-display selection of the user for the current payment method from the one or more payment-method indications; and
upon detecting a change in the payment-method-display selection of the user, cause a re-generation of the user interface portion;
upon determining that the payment method count for the user of the one or more used payment methods is not greater than one, using the one or more used payment methods as the current payment method; and
generating a ledger area of the user interface portion for the current payment method to display information associated with the current payment method and the order payment, the information comprising:
payment-method-account information;
a payment-method status; and
one or more activities associated with the current payment method; and
transmitting, via a computer network, a charge-history user interface comprising the user interface portion to be on the user device for the user.

12. The method in claim 11, wherein one or more of:
when an overall width of the one or more payment-method indications is greater than a width of the payment-method-selection area, the payment-method-selection area is further configured to display the one or more payment-method indications in a multi-page configuration;
the payment-method-selection area is further configured to display a selected payment-method indication associated with the payment-method-display selection differently from one or more unselected payment-method indications of the one or more payment-method indications; or
the user interface portion is configured to overlap the charge-history user interface when displayed on the user device.

13. The method in claim 11, wherein generating the user interface portion further comprises before determining the current payment method, determining the payment method count by:
retrieving, in real-time from a data storage or a server, one or more initial payment methods for the order payment;
for each payment method of the initial payment methods, upon determining that (a) the each payment method is among one or more credit-based payment methods, (b) a respective payment-method status for the each payment method is settled, and (c) a respective final order amount associated with the each payment method and the order payment equals zero, updating the one or more initial payment methods by removing the each payment method from the one or more initial payment methods;
upon determining that the one or more initial payment methods, as updated, is empty, stopping generating the user interface portion; and
upon determining that the one or more initial payment methods, as updated, is not empty:
determining that the payment method count is a size of the one or more initial payment methods, as updated; and
the one or more used payment methods comprise the one or more initial payment methods, as updated.

14. The method in claim 11, wherein generating the ledger area of the user interface portion comprises:
retrieving, in real-time from a data storage or a server, one or more account activities for the current payment method for the order payment;
selectively determining the one or more activities from the one or more account activities based on the payment-method status, wherein one or more of:
when (a) the payment-method status is pending, or (b) the current payment method is among one or more non-credit-based payment methods and the payment-method status is final, the one or more activities comprise the one or more account activities;
when (a) the current payment method is among the one or more credit-based payment methods, and (b) the payment-method status is final, the one or more activities comprise the one or more account activities and a final order charge associated with the current payment method and the order payment; or
when (a) the current payment method is among the one or more credit-based payment methods, and (b) the payment-method status is settled:
the one or more activities comprise the final order charge; and
when the one or more account activities comprise a driver tip payment, the one or more activities further comprises the driver tip payment; and
incorporating for display the one or more activities on the ledger area.

15. The method in claim 14, wherein incorporating for display the one or more activities comprises:
upon determining that (a) the payment-method status is final, and (b) the current payment method is among the one or more credit-based payment methods:
upon determining that the one or more activities comprise the driver tip payment, listing the driver tip payment and the final order charge in a first region of the ledger area;
upon determining that the one or more activities do not comprise the driver tip payment, listing the final order charge in the first region of the ledger area; and
listing one or more remaining activities of the one or more activities reverse chronologically in a second region of the ledger area; and
upon determining that (a) the payment-method status is not final, or (b) the current payment method is among the one or more non-credit-based payment methods, listing the one or more activities reverse chronologically in the ledger area.

16. The method in claim 11, wherein each of the one or more activities is associated with a single one of activity types comprising a temporary hold, an order adjustment, an order charge, a refund, and an additional driver tip.

17. The method in claim 16, wherein:
the temporary hold and the order adjustment are associated with unsettled credit-based payment activities; and
the order charge and the refund are associated with non-credit-based payment activities.

18. The method in claim 11, wherein generating the user interface portion further comprises incorporating for display, on the ledger area, one or more of:
one or more payment-related descriptions each associated with one or more of: the current payment method, the payment-method status, or a first respective account activity of the one or more activities; or
one or more information entry points each configured to, when activated, cause a display of a respective pop-up window showing respective information associated with one or more of: the current payment method, the payment-method status, or a second respective account activity of the one or more activities.

19. The method in claim 11, further comprising:
before generating the user interface portion, generating an order-detail user interface configured to display details for an order associated with the order payment and an entry point, wherein:
the entry point is configured to, when activated, cause a transmission of a request for the charge-history user interface for the order payment from the user device; and
generating the user interface portion further comprises upon receiving the request, generating the user interface portion of the charge-history user interface for the one or more used payment methods.

20. The method in claim 19, wherein generating the order-detail user interface further comprises:
upon determining that (a) each payment method of the one or more used payment methods is among one or more credit-based payment methods, (b) a respective payment-method status for the each payment method is settled, and (c) a respective final order amount associated with the each payment method and the order payment equals zero, removing the entry point from the order-detail user interface.
